(19) United States
(12) Patent Application Publication
(10) Pub. No.: US 2016/0230720 A1
(43) Pub. Date: Aug. 11, 2016

(54) Fluid Conditioning Module

(71) Applicant: Caterpillar Inc., Peoria, IL (US)

(72) Inventors: David E. Hackett, Washington, IL (US); Scott F. Shafer, Morton, IL (US); Steven Y. Tian, Bloomington, IL (US); Martin Lehman, Congerville, IL (US)

(73) Assignee: Caterpillar Inc., Peoria, IL (US)

(21) Appl. No.: 14/617,040

(22) Filed: Feb. 9, 2015

(51) Int. Cl. F02M 37/14; B01D 35/02; B01D 35/26; B01D 35/157

(52) U.S. Cl. CPC F02M 37/14; B01D 35/1573; B01D 35/02; B01D 35/26; F02M 2200/27

(57) ABSTRACT

A fluid conditioning system includes a first filter mount having a first filter inlet port and a first filter outlet port; a motor unit; a recirculation pump unit operatively coupled to the motor unit, an outlet of the recirculation pump unit being fluidly coupled to the first filter inlet port via a first filter inlet conduit, an inlet of the recirculation pump unit being fluidly coupled to the first filter outlet port via a first filter outlet conduit; a second filter mount having a second filter inlet port; and a delivery pump unit operatively coupled to the motor unit. The inlet of the delivery pump unit is fluidly coupled to the first filter outlet port via the first filter outlet conduit, and the outlet of the delivery pump unit is fluidly coupled to the second filter inlet port via a second filter inlet conduit.

### TECHNICAL FIELD

This patent disclosure relates generally to fluid conditioning systems and, more particularly, to fuel conditioning modules for combustion engines.

Reciprocating internal combustion (IC) engines are known for converting chemical energy stored in a fuel supply into mechanical shaft power. A fuel-oxidizer mixture is received in a variable volume of an IC engine defined by a piston translating within a cylinder bore. The fuel-oxidizer mixture burns inside the variable volume to convert chemical energy from the mixture into heat. In turn, expansion of the combustion products within the variable volume performs work on the piston, which may be transferred to an output shaft of the IC engine.

Combustion engines may inject high pressure liquid fuel directly into the variable volume, and a liquid fuel delivery system may employ two or more fuel pumping stages in series to achieve the desired final injection pressure. For example, common rail fuel systems for direct injection compression ignition engines may include a fuel transfer pump that draws fuel from a fuel tank and delivers the fuel to the inlet of a high pressure common rail pump, which further increases the fuel pressure to the desired injection pressure.

Filters have been used to remove unwanted particulates, unwanted fluids (e.g., water), or both, from liquid fuel systems. For example, US Patent Publication No. US2004/0118764 (“the '764 publication”) describes a multiple fuel filter pump module. The dual fuel filter pump module of the '764 publication draws a flow of fuel from a fuel tank and delivers one portion of the fuel flow to an engine fuel supply line, and directs another portion of the fuel flow to the fuel tank via a regulator fuel line for re-circulation through the fuel system. Although the fuel system described in the '764 publication may be used advantageously for some combustion engine applications, other fuel systems may be better tailored to meet the filtration performance and system packaging needs of other combustion engine applications.

Accordingly, there is a need for improved fuel systems to address the aforementioned concerns and/or other problems in the art.

### SUMMARY

According to an aspect of the disclosure, a fluid conditioning system comprises a first filter mount having a first filter inlet port and a first filter outlet port; a first motor; a first pump operatively coupled to the first motor, an outlet of the first pump being fluidly coupled to the first filter inlet port via a first filter inlet conduit, an inlet of the first pump being fluidly coupled the first filter outlet port via a first filter outlet conduit; a second filter mount having a second filter inlet port; a second pump, an inlet of the second pump being fluidly coupled to the first filter outlet port via the first filter outlet conduit, an outlet of the second pump being fluidly coupled to the second filter inlet port via a second filter inlet conduit; and a controller operatively coupled to the first motor, the controller being configured to operate the first pump at a flowrate that is higher than a flowrate of the second pump.

According to another aspect of the disclosure, a fluid conditioning module comprises a block defining a first filter inlet port, a first filter outlet port, a second filter inlet port, and a second filter outlet port; a first pump fastened to the block, an outlet of the first pump being fluidly coupled to the first filter inlet port via a first filter inlet conduit defined by the block, an inlet of the first pump being fluidly coupled to the first filter outlet port via a first filter outlet conduit defined by the block; and a second pump fastened to the block, an outlet of the second pump being fluidly coupled to the second filter inlet port via a second filter inlet conduit defined by the block, an inlet of the second pump being fluidly coupled to the first filter outlet port via the first filter outlet conduit.

According to another aspect of the disclosure, a method for conditioning a fluid includes comprises pumping a fluid flow through a first pump; filtering the fluid flow through a first filter; recirculating a first portion of the fluid flow through the first filter via the first pump; pumping a second portion of the fluid flow through a second pump, the second portion of the fluid flow being less than the first portion of the fluid flow; and filtering the second portion of the fluid flow through a second filter.

According to another aspect of the disclosure, a fluid conditioning module comprises a block, a first pump fastened to the block, a second pump fastened to the block, a first filter removably coupled to the block, an inlet of the first filter being fluidly coupled to an outlet of the first pump via a first filter inlet conduit defined by the block, an outlet of the first filter being fluidly coupled to an inlet of the first pump via a first filter outlet conduit, and a second filter removably coupled to the block, an inlet of the second filter being fluidly coupled to an outlet of the second pump via a second filter inlet conduit defined by the block, an inlet of the second pump being fluidly coupled to the outlet of the first filter via the first filter outlet conduit.

According to another aspect of the disclosure, a fluid conditioning system comprises a first filter mount having a first filter inlet port and a first filter outlet port; a motor unit; a recirculation pump unit operatively coupled to the motor unit, an outlet of the recirculation pump unit being fluidly coupled to the first filter inlet port via a first filter inlet conduit, an inlet of the recirculation pump unit being fluidly coupled to the first filter outlet port via a first filter outlet conduit; a second filter mount having a second filter inlet port; and a delivery pump unit operatively coupled to the motor unit. The delivery pump unit includes a plurality of delivery pumps, an inlet of each delivery pump of the plurality of delivery pumps being fluidly coupled to an inlet of the delivery pump unit, and an outlet of each delivery pump of the plurality of delivery pumps being fluidly coupled to an outlet of the delivery pump unit. The inlet of the delivery pump unit is fluidly coupled to the first filter outlet port via the first filter outlet conduit, and the outlet of the delivery pump unit is fluidly coupled to the second filter inlet port via a second filter inlet conduit.

According to another aspect of the disclosure, a fluid conditioning module comprises a block defining a first filter inlet port, a first filter outlet port, a second filter inlet port, and a second filter outlet port; a recirculation pump unit fastened to the block, an outlet of the recirculation pump unit being fluidly coupled to the first filter inlet port via a first filter inlet conduit defined by the block, an inlet of the recirculation pump unit being fluidly coupled to the first filter outlet port via a first filter outlet conduit defined by the block; and a delivery pump unit fastened to the block. The delivery pump unit includes a plurality of delivery pumps, an inlet of each delivery pump of the plurality of delivery pumps being fluidly coupled to an inlet of the delivery pump unit, and an outlet of each delivery pump of the plurality of delivery pumps being fluidly coupled to an outlet of the delivery pump unit. The outlet of the delivery pump unit is fluidly coupled to the second filter inlet port via a second filter inlet conduit defined by the block, and the inlet of the delivery pump unit is fluidly coupled to the first filter outlet port via the first filter outlet conduit.

### BRIEF DESCRIPTION OF THE DRAWINGS

FIG. 1 shows a side view of a machine, according to an aspect of the disclosure.

FIG. 2 shows a schematic view of a fuel supply system, according to an aspect of the disclosure.

FIG. 3 shows a schematic view of a fluid conditioning module, according to an aspect of the disclosure.

FIG. 4 shows a schematic view of a fluid conditioning module, according to an aspect of the disclosure.

FIG. 5 shows a perspective view of a fluid conditioning module, according to an aspect of the disclosure.

FIG. 6 shows a partial cross sectional view of the fluid conditioning module illustrated in FIG. 5, according to an aspect of the disclosure.

FIG. 7 shows a partial cross sectional view of the fluid conditioning module illustrated in FIG. 5, according to an aspect of the disclosure.

FIG. 8 shows a partial cross sectional view of the fluid conditioning module illustrated in FIG. 5, according to an aspect of the disclosure.

FIG. 9 shows a schematic view of a fluid conditioning module, according to an aspect of the disclosure.

FIG. 10 shows a schematic view of a delivery pump unit, according to an aspect of the disclosure.

FIG. 11 shows a schematic view of a delivery pump unit, according to an aspect of the disclosure.

FIG. 12 shows a schematic view of a motor unit, according to an aspect of the disclosure.

FIG. 13 shows a schematic view of a motor unit, according to an aspect of the disclosure.

FIG. 14 shows a schematic side view of a fluid conditioning module, according to an aspect of the disclosure.

FIG. 15 shows a schematic side view of a fluid conditioning module, according to an aspect of the disclosure.

FIG. 16 shows a schematic side view of a fluid conditioning module, according to an aspect of the disclosure.

### DETAILED DESCRIPTION

Aspects of the disclosure will now be described in detail with reference to the drawings, wherein like reference numbers refer to like elements throughout, unless specified otherwise.

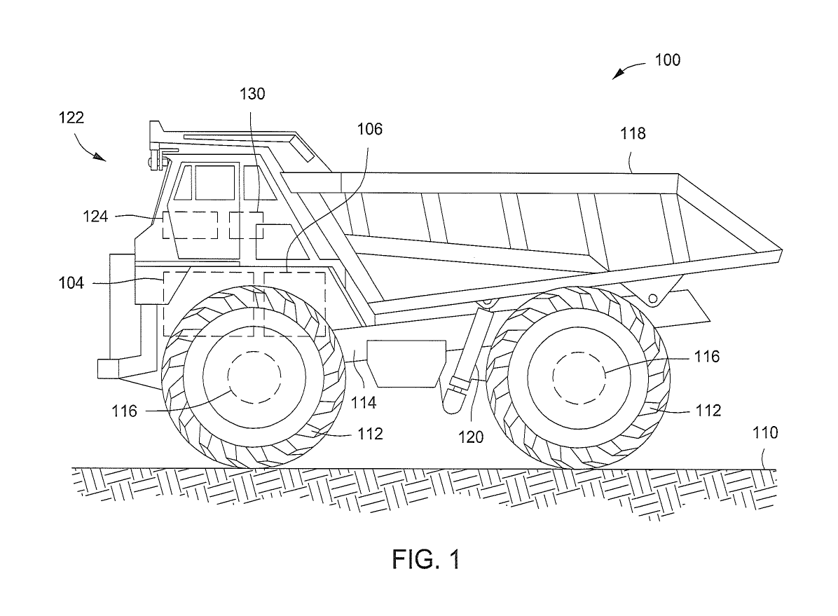

FIG. 1 shows a side view of a machine 100, according to an aspect of the disclosure. The machine 100 includes an internal combustion (IC) engine 104 that is fluidly coupled to a fuel supply system 106. The IC engine 104 maybe a reciprocating internal combustion engine, such as a compression ignition engine or a spark ignition engine, for example, or a rotating internal combustion engine, such as a gas turbine, for example.

The machine 100 may be propelled over a work surface 110 by wheels 112 coupled to a chassis 114. The wheels 112 may be driven by motors 116, a mechanical transmission coupled to the IC engine 104, or combinations thereof. It will be appreciated that the machine 100 could also be propelled by tracks (not shown), combinations of wheels 112 and tracks, or any other surface propulsion device known in the art. Alternatively, the machine 100 could be a stationary machine, and therefore may not include a propulsion device.

The machine 100 may also include a work implement 118 driven by an actuator 120. The work implement 118 could be a dump bed, a shovel, a drill, a fork lift, a feller-buncher, a conveyor, or any other implement known in the art for performing work on a load. The actuator 120 may be a hydraulic actuator, such as a linear hydraulic motor or a rotary hydraulic motor, an electric motor, a pneumatic actuator, or any other actuator known in the art.

The machine may include a cab 122 configured to accommodate an operator, and have a user interface 124 including using input devices for asserting control over the machine 100. The user interface 124 may include pedals, wheels, joysticks, buttons, touch screens, combinations thereof, or any other user input device known in the art. Alternatively or additionally, the user interface 124 may include provisions for receiving control inputs remotely from the cab 122, including wired or wireless telemetry, for example. The IC engine 104, the fuel supply system 106, and the user interface 124 may be operatively coupled to one another via a machine controller 130.

The machine can be an “over-the-road” vehicle such as a truck used in transportation or may be any other type of machine that performs some type of operation associated with an industry such as mining, construction, farming, transportation, or any other industry known in the art. For example, the machine may be an off-highway truck; an earth-moving machine, such as a wheel loader, an excavator, a dump truck, a backhoe, a motor grader, or a material handler; a marine vehicle or machine; a locomotive; or any other machine known in the art. The term “machine” can also refer to stationary equipment, such as a generator that is driven by an internal combustion engine to generate electricity. The specific machine 100 illustrated in FIG. 1 is a dump truck having a dump bed 118 actuated by a linear hydraulic cylinder 120.

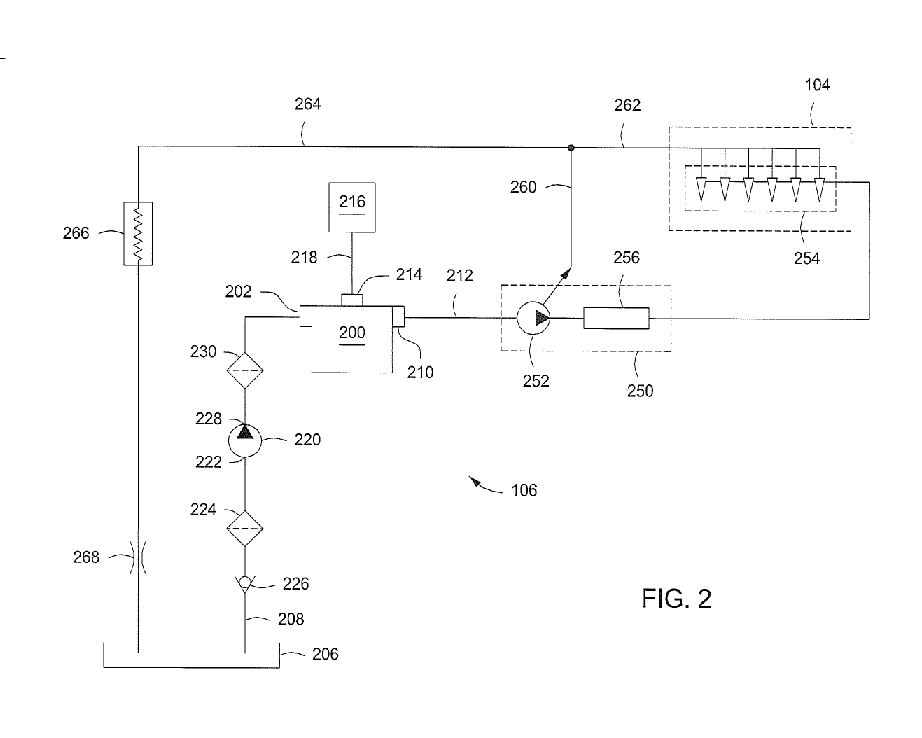

FIG. 2 shows a schematic view of a fuel supply system 106, according to an aspect of the disclosure. The fuel supply system 106 includes a fluid conditioning module 200 having an inlet port 202 that is in fluid communication with a fuel reservoir 206 via a fuel suction conduit 208. An outlet port 210 of the fluid conditioning module 200 may be in fluid communication with the IC engine 104 via a module outlet conduit 212. The fluid conditioning module 200 may include pumps, valves, filters, sensors, heaters, coolers, controllers, combinations thereof, or any other structures known in the art to be beneficial to conditioning a fluid.

A power port 214 of the fluid conditioning module 200 is operatively coupled to a power source 216 via a power conduit 218. The power source 216 may be an electrical power source, a hydraulic power source, a pneumatic power source, a shaft power source, combinations thereof, or any other power source known in the art. The power conduit 218 may include an electrical conductor, a fluid conduit, a shaft, or any other means for transmitting power known in the art. According to an aspect of the disclosure, the power source 216 is an electrical power source, and the power conduit 218 consists of one or more electrical conductors.

The fluid conditioning module 200 may be fluidly coupled to the fuel reservoir 206 via a low-pressure transfer pump 220, which takes suction from the fuel reservoir 206 via the fuel suction conduit 208. Alternatively, the fluid conditioning module 200 includes a pump, and the fuel reservoir 206 may provide sufficient net positive suction head to the fluid conditioning module 200 such that the low-pressure transfer pump 220 is not necessary, and is therefore not included in the fuel supply system 106.

An inlet 222 of the low-pressure transfer pump 220 may be fluidly coupled to the fuel reservoir 206 via a filter or strainer 224, a check valve 226, or both. Alternatively or additionally, an outlet 228 of the low-pressure transfer pump 220 may be fluidly coupled to the inlet port 202 of the fluid conditioning module 200 via a filter or strainer 230. Further, it will be appreciated that the inlet port 202 of the fluid conditioning module 200 may be fluidly coupled to the fuel reservoir 206 via the filter or strainer 224, the check valve 226, or both, independent of whether the fuel supply system 106 includes the low-pressure transfer pump 220. The check valve 226 is configured to allow flow through the suction conduit 208 only in a direction from the fuel reservoir 206 toward the fluid conditioning module 200.

According to the aspect illustrated in FIG. 2, the outlet port 210 of the fluid conditioning module 200 is fluidly coupled to the IC engine 104 via a high-pressure pump system 250, which includes a high-pressure pump 252. The high-pressure pump 252 may be a high-pressure unit pump that is coupled to a single fuel injector of the IC engine 104, or a high-pressure common rail pump that is fluidly coupled to two or more fuel injectors 254 of the IC engine 104 via a common rail 256. Therefore, according to an aspect of the disclosure, the fluid conditioning module 200 is in fluid communication with the IC engine 104 via at least one pump disposed downstream of the outlet port 210 of the fluid conditioning module 200 along a direction of fuel flow through the module outlet conduit 212.

The fuel reservoir 206 may be in fluid communication with a pump drain conduit 260, a fuel injector drain conduit 262, or both, via a return conduit 264. The return conduit 264 may optionally include a heat exchanger 266 that is configured to transfer heat away from a flow of fuel through the return conduit 264. Further, the return conduit 264 may include an air bleed device 268 for separating gases from liquid fuel flowing through the return conduit 264 upstream of the fuel reservoir 206. The fuel reservoir 206 may be a liquid fuel reservoir that supplies one or more liquid fuels to the IC engine 104, such as, distillate diesel, biodiesel, dimethyl ether, seed oils, ethanol, methanol, combinations thereof, or any other combustible liquid known in the art.

Although the fluid conditioning module 200 is shown in the context of a fuel supply system 106 in FIG. 2, it will be appreciated that the fluid conditioning module 200 could be used to condition other fluids, such as, hydraulic fluid, coolant, water, lubricating oil, combinations thereof, or any other fluid known in the art. Unless specified otherwise, the term “fluid” is used herein to describe gases, liquids, slurries, combinations thereof, or other similar matter that tends to flow in response to applied sheer stress.

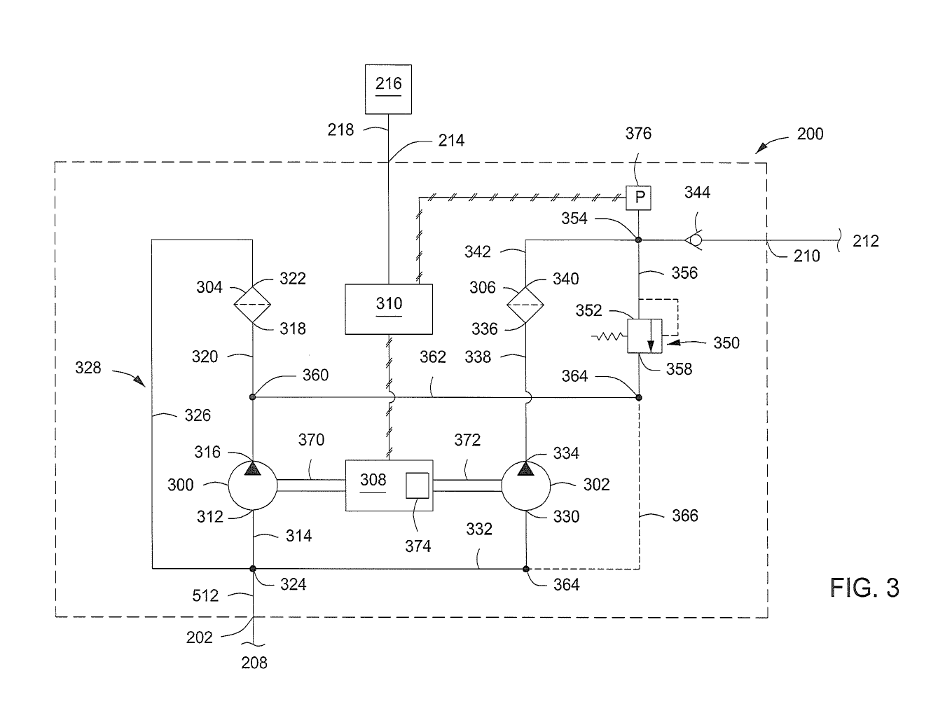

FIG. 3 shows a schematic view of a fluid conditioning module 200, according to an aspect of the disclosure. The fluid conditioning module 200 includes a first pump 300, a second pump 302, a first filter 304, a second filter 306, a motor 308, and a module controller 310.

An inlet 312 to the first pump 300 is fluidly coupled to the inlet port 202 of the fluid conditioning module 200, and therefore the fuel suction conduit 208, via a first pump inlet conduit 314. An outlet 316 from the first pump 300 is fluidly coupled to an inlet port 318 of the first filter 304 via a first filter inlet conduit 320. An outlet port 322 of the first filter 304 is fluidly coupled to the first pump inlet conduit 314 at a node 324 via a first filter outlet conduit 326. Accordingly, the first filter inlet conduit 320, the first filter outlet conduit 326, and the first pump inlet conduit 314 form a fluid recirculation loop 328 about the first pump 300, which includes the first filter 304.

An inlet 330 to the second pump 302 is fluidly coupled to the node 324 via a second pump inlet conduit 332. In turn, the inlet 330 of the second pump 302 is fluidly coupled to the first filter outlet conduit 326 and the inlet port 202 of the fluid conditioning module 200 via the second pump inlet conduit 332. According to an aspect of the disclosure, the first pump 300 may be a turbomachine, such as, for example, a centrifugal pump. According to another aspect of the disclosure, the second pump 302 may have a positive displacement design, such as, for example a gerotor or external gear pump construction. However, it will be appreciated that either the first pump 300 or the second pump 302 may be a turbomachine, a positive displacement pump, or any other pump known in the art, to satisfy the needs of a particular application.

An outlet 334 from the second pump 302 is fluidly coupled to an inlet port 336 of the second filter 306 via a second filter inlet conduit 338. An outlet port 340 of the second filter 306 is fluidly coupled to the outlet port 210 of the fluid conditioning module 200 via a second filter outlet conduit 342. The second filter outlet conduit 342 may include a check valve 344 that is configured to allow flow only in a direction from the second filter 306 toward the outlet port 210 of the fluid conditioning module 200.

The fluid conditioning module 200 may include a pressure regulating valve 350 having an inlet 352 that is fluidly coupled to the second filter outlet conduit 342 at a node 354 via a regulating valve inlet conduit 356. Although FIG. 2 shows the node 354 located upstream of the check valve 344, it will be appreciated that the node 354 could be located anywhere along the second filter inlet conduit 338 and the second filter outlet conduit 342.

An outlet 358 of the pressure regulating valve 350 is fluidly coupled to the first filter inlet conduit 320 at a node 360 via a first drain conduit 362. Accordingly, the outlet 358 of the pressure regulating valve 350 is fluidly coupled to the inlet port 318 of the first filter 304 via the first drain conduit 362. Alternatively or additionally, the outlet 358 of the pressure regulating valve 350 may be fluidly coupled to the second pump inlet conduit 332 at a node 364 via a second drain conduit 366. In turn, the outlet 358 of the pressure regulating valve 350 may be in fluid communication with the inlet 312 to the first pump 300 and the inlet to the second pump 302 via the second drain conduit 366.

The pressure regulating valve 350 has a first configuration that blocks fluid communication between the inlet 352 and the outlet 358 of the pressure regulating valve 350, and a second configuration that effects fluid communication between the inlet 352 and the outlet 358 of the pressure regulating valve 350. Further, the pressure regulating valve 350 may actuate between its first configuration and its second configuration based on a difference between the pressure at the inlet 352 and a predetermined threshold value. According to an aspect of the disclosure, the pressure regulating valve 350 may toggle from its first configuration to its second configuration when the pressure at the inlet 352 exceeds a predetermined threshold value. According to another aspect of the disclosure, the pressure regulating valve 350 may operate proportionally between its first configuration and a wide open position based on a difference between the pressure at the inlet 352 and a predetermined threshold value.

The first pump 300 is operatively coupled to the motor 308 via a first shaft 370 for transmission of shaft power therebetween, and the second pump 302 is operatively coupled to the motor 308 via a second shaft 372 for transmission of shaft power therebetween. The motor 308 may be powered by electrical power, hydraulic power, pneumatic power, combinations thereof, or any other motor power source known in the art.

According to an aspect of the disclosure, the motor 308 is configured to drive the first shaft 370 at the same angular velocity as the second shaft 372. According to another aspect of the disclosure, the motor 308 may include gearing 374 operatively coupled to the first shaft 370, the second shaft 372, or both, such that an angular velocity for the first shaft 370 is different from the angular velocity of the second shaft according to a prescribed relationship as a function of the angular velocity of the motor 308.

The motor 308 is operatively coupled to the module controller 310 for control thereof, and the module controller 310 is operatively coupled to the power source 216 at the power port 214 via the power conduit 218, as described previously. The fluid conditioning module 200 may include a pressure sensor 376 that is in fluid communication with the second filter outlet conduit 342, and operatively coupled to the module controller 310 for transmission of data signals, power, or both, therebetween. Accordingly, the module controller 310 may exchange data signals, power transmission, or both, with the motor 308 or the pressure sensor 376.

According to an aspect of the disclosure, the motor 308 is a variable speed motor and the module controller 310 is configured to vary a rotational speed of the motor 308. Further, the module controller 310 may be configured to vary a speed of the motor 308 based on a comparison between a pressure signal from the pressure sensor 376 and a predetermined threshold value. According to another aspect of the disclosure, the motor 308 is a constant speed motor, and the module controller 310 is configured to actuate the motor 308 between a stopped condition and a fixed-speed condition.

The module controller 310 may be any purpose-built processor for effecting control of the fluid conditioning module 200. It will be appreciated that the module controller 310 may be embodied in a single housing, or a plurality of housings distributed throughout the fluid conditioning module 200. Further, the module controller 310 may include power electronics, preprogrammed logic circuits, data processing circuits, volatile memory, non-volatile memory, software, firmware, input/output processing circuits, combinations thereof, or any other controller structures known in the art.

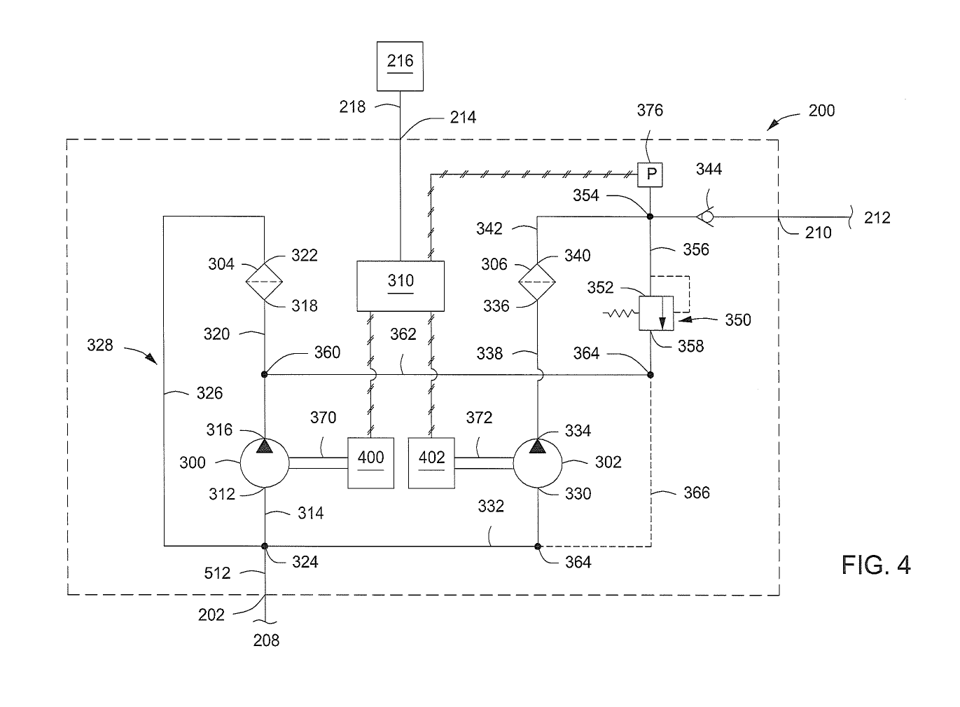

FIG. 4 shows a schematic view of a fluid conditioning module 200, according to an aspect of the disclosure. Similar to FIG. 3, the fluid conditioning module 200 in FIG. 4 includes the first pump 300, the second pump 302, the first filter 304, the second filter 306, and the module controller 310. However, the fluid conditioning module 200 in FIG. 4 further includes a first motor 400 operatively coupled to the first pump 300 via the first shaft 370, and a second motor 402 operatively coupled to the second pump 302 via the second shaft 372. The first motor 400 and the second motor 402 may each be operatively coupled to the module controller 310 for control thereof. Either of the first motor 400 or the second motor 402 may be powered by electrical power, hydraulic power, pneumatic power, or any other motor power source known in the art. According to an aspect of the disclosure, the first shaft 370 is free from any mechanical coupling with the second shaft 372 that would prohibit rotation of the first shaft 370 independent of rotation with the second shaft 372.

The first motor 400 and the second motor 402 may embody various combinations of fixed-speed and variable-speed characteristics as outlined below. According to an aspect of the disclosure, both the first motor 400 and the second motor 402 are variable speed motors, and the module controller 310 is configured to operate each of the first motor 400 and the second motor 402 at speeds independent of one another. According to another aspect of the disclosure, the first motor 400 is a variable speed motor and the second motor 402 is a fixed speed motor, and the module controller 310 is configured to operate the first motor 400 at a speed that is independent of a speed of the second motor 402. According to another aspect of the disclosure, the first motor 400 is a fixed speed motor and the second motor 402 is a variable speed motor, and the module controller 310 is configured to operate the second motor 402 at a speed that is independent of a speed of the first motor 400.

According to another aspect of the disclosure, both the first motor 400 and the second motor 402 are fixed speed motors, and the controller is configured to operate the first motor 400 and the second motor 402 independent of one another. It will be appreciated that the first motor 400 may have a fixed operating speed that is the same as or different from a fixed operating speed of the second motor 402.

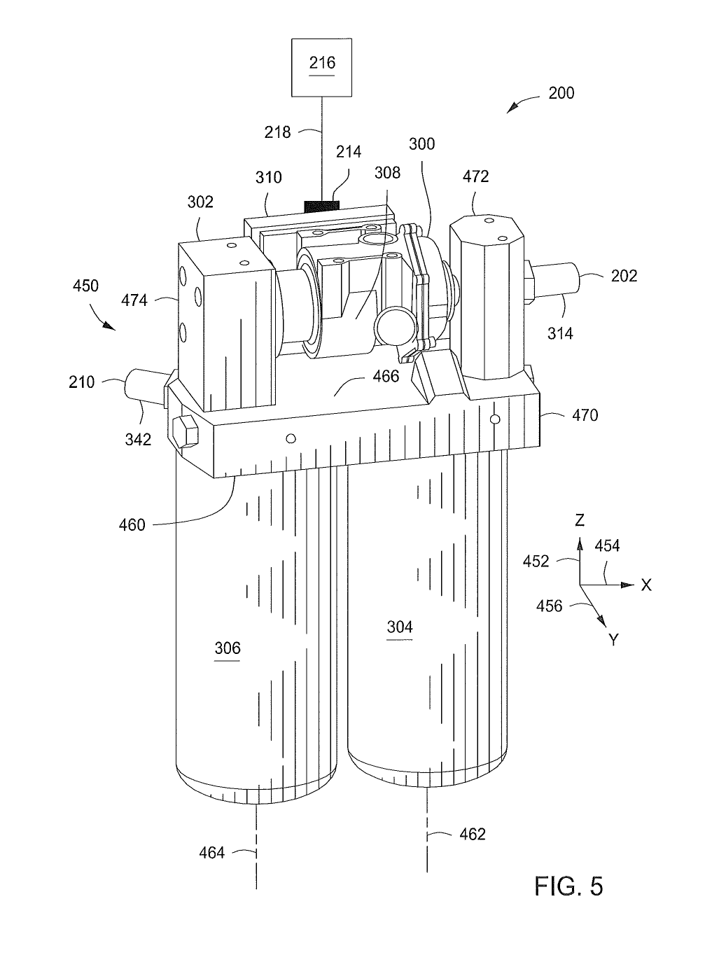

FIG. 5 shows a perspective view of a fluid conditioning module 200, according to an aspect of the disclosure. The fluid conditioning module 200 may include a block 450 that functions to provide points of attachment for any of the components of the fluid conditioning module 200, to define fluid passages to effect fluid communication between components of the fluid conditioning module 200, or combinations thereof. It will be appreciated that the block 450 may be formed and consist of a single unitary part, or alternatively, the block 450 may include a plurality of parts fastened to one another by threaded fasteners, rivets, welding, brazing, interference fits, combinations thereof, or any other material fasteners or techniques known in the art.

In FIG. 5, a height or vertical direction 452 extends along the z-axis, a width direction 454 extends along the x-axis, and a depth direction 456 extends along the y-direction, where the x-axis, the y-axis, and the z-axis may all be mutually normal or perpendicular to one another.

The first filter 304 and the second filter 306 are each mounted to a lower surface 460 of the block 450. A longitudinal axis 462 of the first filter 304 and a longitudinal axis 464 of the second filter 306 may each extend away from the lower surface 460 of the block along the height direction 452. The longitudinal axis 462 of the first filter 304 may be substantially parallel to the longitudinal axis 464 of the second filter 306. Further, the longitudinal axis 462 of the first filter 304 and the longitudinal axis 464 of the second filter 306 may each lie in a plane defined by the width direction 454 and the height direction 452.

The block 450 may define the inlet port 202, the outlet port 210, or both, of the fluid conditioning module 200. It will be appreciated that the block 450 may include fluid fittings coupled thereto, and that such fluid fittings may be said to part of the block 450 and define the inlet port 202, the outlet port 210, or both.

As shown in FIG. 5, the block 450 includes a first block portion 470, a second block portion 472 fastened to the upper surface 466 of the first block portion 470, and a third block portion 474 fastened to the upper surface 466 the first block portion 470. The second block portion 472 and the third block portion 474 each extend away from the upper surface 466 of the first block portion 470 along the height direction 452. Alternatively, it will be appreciated that combinations of the first block portion 470, the second block portion 472, and third block portion 474 may be machined, cast, or otherwise formed as a single unitary piece.

The second pump 302 may be disposed at least partly within the third block portion 474. According to an aspect of the disclosure, the second pump 302 is disposed completely within the third block portion 474, except for the second shaft 372, which may extend outside the third block portion 474 to the motor 308. As discussed below, each of the first block portion 470, the second block portion 472, and the third block portion 474 may define fluid passages therein, thereby effecting fluid communication between the various components of the fluid conditioning module 200.

The first pump 300, the second pump 302, and the motor 308 are shown fastened to an upper surface 466 of the first block portion 470, where the upper surface 466 of the block 450 is opposite the lower surface 460 of the block along the height direction 452. The first pump 300, the second pump 302, and the motor 308 may be fastened to the block 450 by threaded fasteners, or any other fasteners known in the art. Although only one motor 308 is shown in FIG. 5, it will be appreciated that the motor 308 could be replaced by the first motor 400 and the second motor 402 shown schematically in FIG. 4, without changing the arrangement of the first pump 300, the first shaft 370, the second pump 302, and the second shaft 372 along the width direction 454.

The second block portion 472 and the third block portion 474 each extend away from the upper surface 466 of the first block portion 470 along the height direction 452. The second pump 302 may be disposed at least partly within the third block portion 474. According to an aspect of the disclosure, the second pump 302 is disposed completely within the third block portion 474, except for the second shaft 372, which extends outside the third block portion 474 to the motor 308.

The module controller 310 may be fastened to the motor 308, or otherwise fastened to the block 450, either directly or indirectly through another component. As discussed previously, the module controller 310 receives power from a power source 216 via a power conduit 218 coupled to the power port 214 of the fluid conditioning module 200.

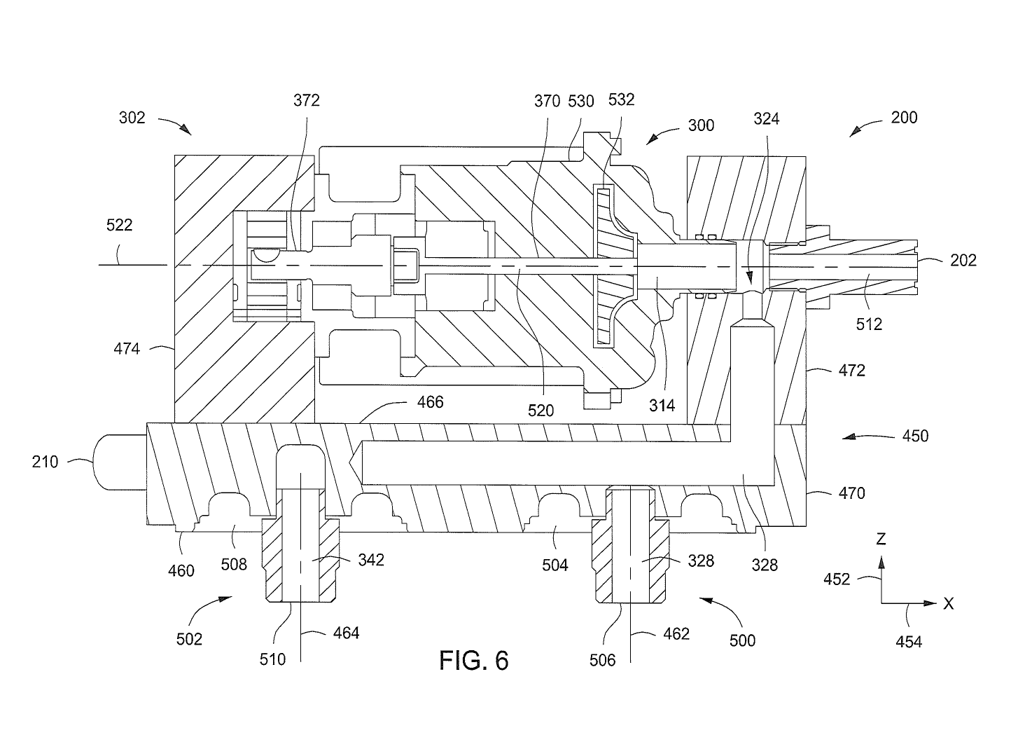

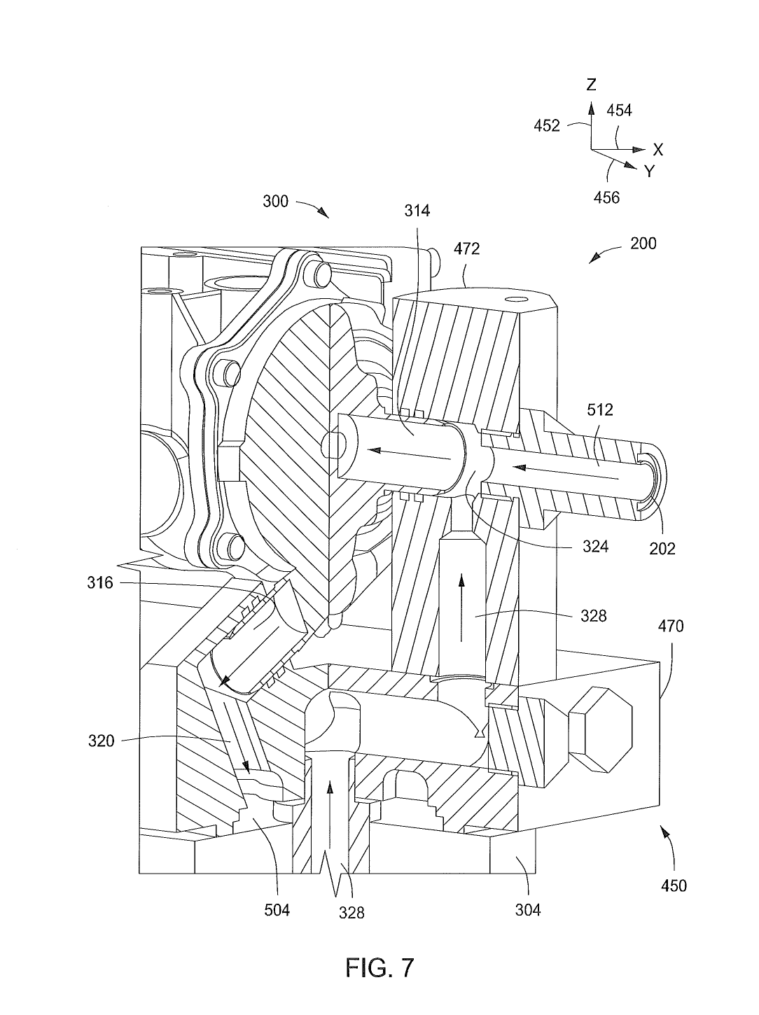

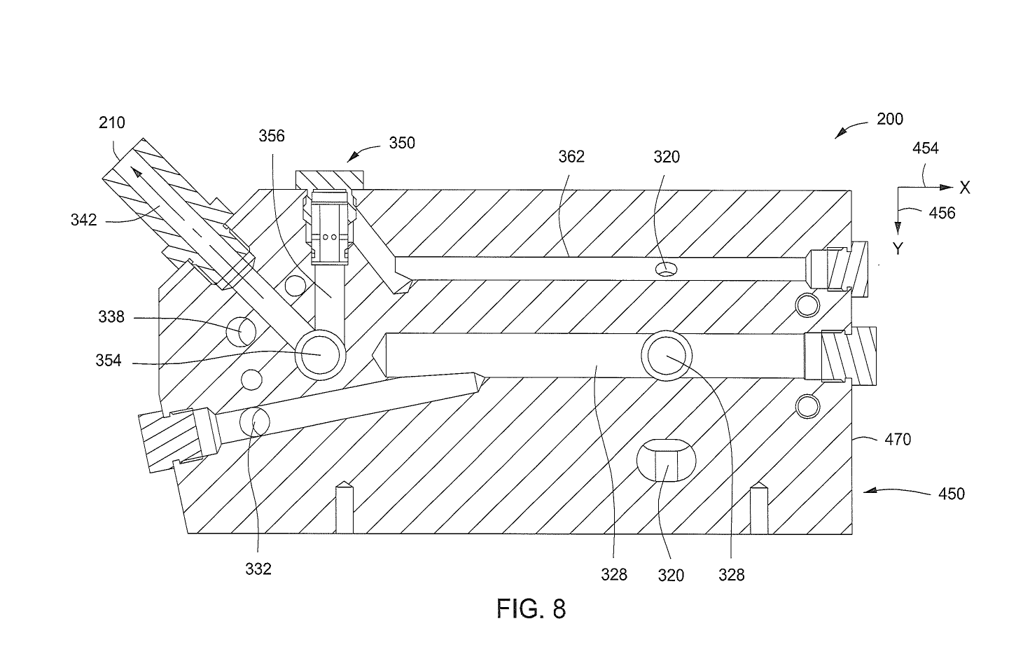

Referring now to FIGS. 6-8, FIG. 6 shows a partial cross sectional view of the fluid conditioning module 200 illustrated in FIG. 5, according to an aspect of the disclosure; FIG. 7 shows a partial cross sectional view of the fluid conditioning module 200 illustrated in FIG. 5, according to an aspect of the disclosure; and FIG. 8 shows a partial cross sectional view of the fluid conditioning module 200 shown in FIG. 5, according to an aspect of the disclosure.

In FIG. 6, the fluid conditioning module 200 is shown without the first filter 304 and the second filter 306, to illustrate the a first filter mount 500 and a second filter mount 502, defined by the lower surface 460 of the block 450. The first filter mount 500 may define a first filter inlet aperture or port 504, which may effectively define a downstream terminal end of the first filter inlet conduit 320 (see FIG. 8), and may define a first filter outlet aperture or port 506, which may effectively define an upstream terminal end of the first filter outlet conduit 326. The second filter mount 502 may define a second filter inlet aperture or port 508, which may effectively define a downstream terminal end of the second filter inlet conduit 338 (see FIG. 3), and may define a second filter outlet aperture or port 510, which may effectively define an upstream terminal end of the second filter outlet conduit 342. The first filter mount 500 and the second filter mount 502 may also include filter fastening features, such as, for example, internal threads, external threads, clamps, or other filter fastening structures known in the art.

Each of the first block portion 470, the second block portion 472, and the third block portion 474 may define fluid passages therein, thereby effecting fluid communication between the various components of the fluid conditioning module 200. For example, as shown in FIGS. 6 and 7, the second block portion 472 may define the fluid node 324 therein, such that the second block portion 472 effects fluid communication between the first filter outlet conduit 326, the first pump inlet conduit 314, the second pump inlet conduit 332 (see FIG. 7), and a module inlet conduit 512. Further as shown in FIG. 8, the first block portion 470 may define the fluid node 354 therein, such that the first block portion 470 effects fluid communication between the second filter outlet conduit 342 and the first drain conduit 362 via the pressure regulating valve 350.

Referring to FIG. 6, a longitudinal axis 520 of the first shaft 370 may be substantially parallel with a longitudinal axis 522 of the second shaft 372. According to another aspect of the disclosure, the longitudinal axis 520 of the first shaft 370 may be substantially collinear with the longitudinal axis 522 of the second shaft 372. Further, each of the longitudinal axis 520 of the first shaft 370 and the longitudinal axis 522 of the second shaft 372 may be substantially aligned with the width direction 454.

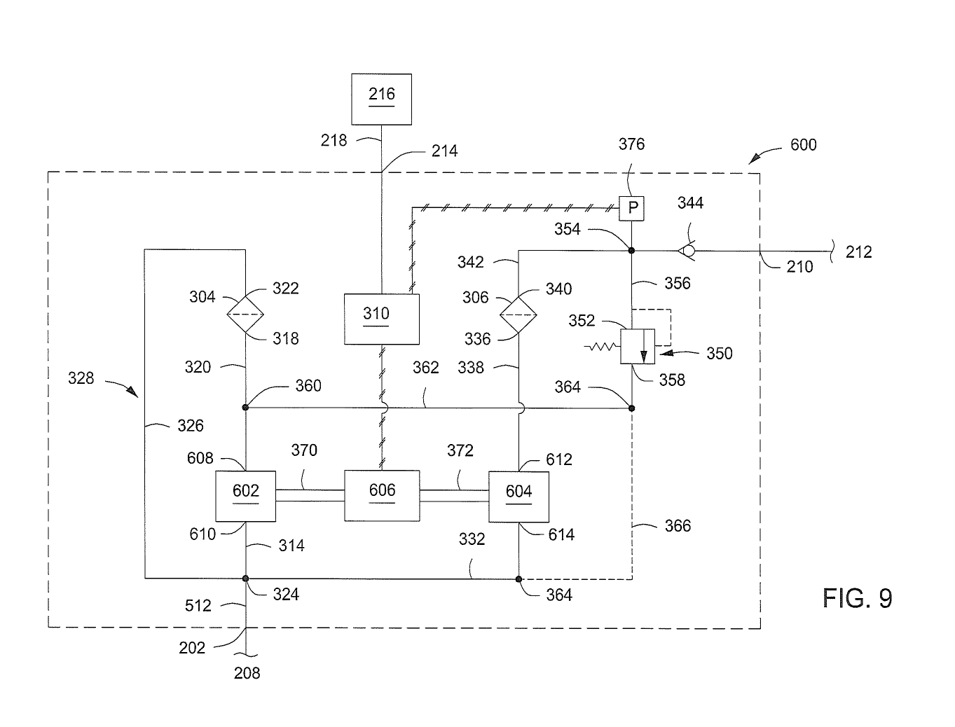

FIG. 9 shows a schematic view of a fluid conditioning module 600, according to an aspect of the disclosure. The fluid conditioning module 600 is similar to the fluid conditioning module 200 shown in FIG. 3; however, the fluid conditioning module 600 includes a recirculation pump unit 602 in place of the first pump 300, a delivery pump unit 604 in place of the second pump 302, and a motor unit 606 in place of the motor 308. The recirculation pump unit 602 may include one or more pumps, and the delivery pump unit 604 may include one or more pumps. The motor unit 606 is operatively coupled to the module controller 310 and may include one or more motors. The recirculation pump unit 602 and the delivery pump unit 604 may share common features or attributes with the first pump 300 and the second pump 302, respectively. Further, it will be appreciated that the fluid conditioning module 600 may otherwise have any of the features, fluid connections, applications, or attributes of the fluid conditioning module 200 illustrated in FIGS. 2-8, for example.

An outlet 608 of the recirculation pump unit 602 is fluidly coupled to the inlet port 318 of the first filter 304 via the first filter inlet conduit 320, and an inlet 610 of the recirculation pump unit 602 is fluidly coupled to the fluid node 324. The recirculation pump unit 602 is operatively coupled to the motor unit 606 via the first shaft 370. Accordingly, the recirculation pump unit 602 is configured to receive shaft power from the motor unit 606 and recirculate a flow of fluid through the fluid recirculation loop 328.

According to an aspect of the disclosure, the recirculation pump unit 602 includes a centrifugal pump. According to another aspect of the disclosure, the centrifugal pump includes a housing 530 (see FIG. 6) configured to receive an impeller 532 (see FIG. 6) from a plurality of impellers, where each impeller 532 of the plurality of impellers effects a unique flow-versus-pressure rise characteristic when operating within the housing 530.

An outlet 612 of the delivery pump unit 604 is fluidly coupled to the inlet port 336 of the second filter 306 via the second filter inlet conduit 338, and an inlet 614 of the delivery pump unit 604 is fluidly coupled to the fluid node 364. The delivery pump unit 604 is operatively coupled to the motor unit 606 via the second shaft 372. Accordingly, the delivery pump unit 604 is configured to receive shaft power from the motor unit 606 and deliver a flow of fluid through the second filter 306.

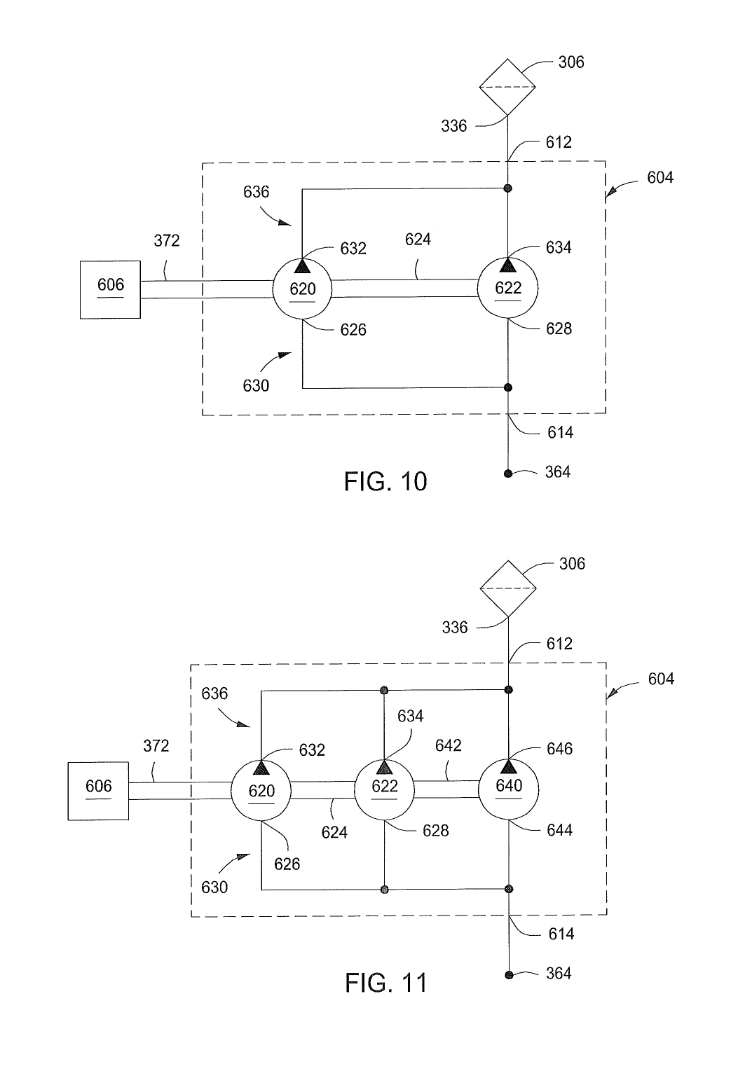

FIG. 10 shows a schematic view of a delivery pump unit 604, according to an aspect of the disclosure. In FIG. 10, the delivery pump unit 604 includes a first delivery pump 620 and a second delivery pump 622. The first delivery pump 620 is operatively coupled to the motor unit 606 via the shaft 372, and operatively coupled to the second delivery pump 622 via a shaft 624. It will be appreciated that the shaft 372 and the shaft 624 may be integrated into one unitary shaft, or comprise a plurality of shafts fastened together for transmitting torque therebetween.

The first delivery pump 620 and the second delivery pump 622 are plumbed in parallel, such that an inlet 626 of the first delivery pump 620 and an inlet 628 of the second delivery pump 622 are fluidly coupled to the inlet 614 of the delivery pump unit 604 via an inlet manifold 630, and an outlet 632 of the first delivery pump 620 and an outlet 634 of the second delivery pump 622 are fluidly coupled to the outlet 612 of the delivery pump unit 604 via an outlet manifold 636. Accordingly, both the first delivery pump 620 and the second delivery pump 622 receive fluid from node 364 via the inlet manifold 630, and deliver fluid to the inlet port 336 of the second filter 306 via the outlet manifold 636.

FIG. 11 shows a schematic view of a delivery pump unit 604, according to an aspect of the disclosure. Similar to FIG. 10, the delivery pump unit 604 illustrated in FIG. 11 includes a first delivery pump 620 and a second delivery pump 622, but further includes a third delivery pump 640. The third delivery pump 640 is operatively coupled to the second delivery pump 622 via a shaft 642. It will be appreciated that the shaft 372, the shaft 624, and the shaft 642 may be integrated into one unitary shaft, or comprise a plurality of shafts fastened together for transmitting torque therebetween.

The third delivery pump 640 is plumbed in parallel with both the first delivery pump 620 and the second delivery pump 622, such an inlet 644 of the third delivery pump 640 is in fluid communication with the inlet 614 of the delivery pump unit 604 via the inlet manifold 630, and an outlet 646 of the third delivery pump is in fluid communication with the outlet 612 of the delivery pump unit 604 via the outlet manifold 636. It will be appreciated that the delivery pump unit 604 may include any number of delivery pumps greater than or equal to two, which are plumbed in parallel with one another to suit a particular application.

According to an aspect of the disclosure, the first delivery pump 620, the second delivery pump 622, the third delivery pump 640, or combinations thereof, are positive displacement pumps. According to another aspect of the disclosure, the first delivery pump 620, the second delivery pump 622, the third delivery pump 640, or combinations thereof are gerotor positive displacement pumps.

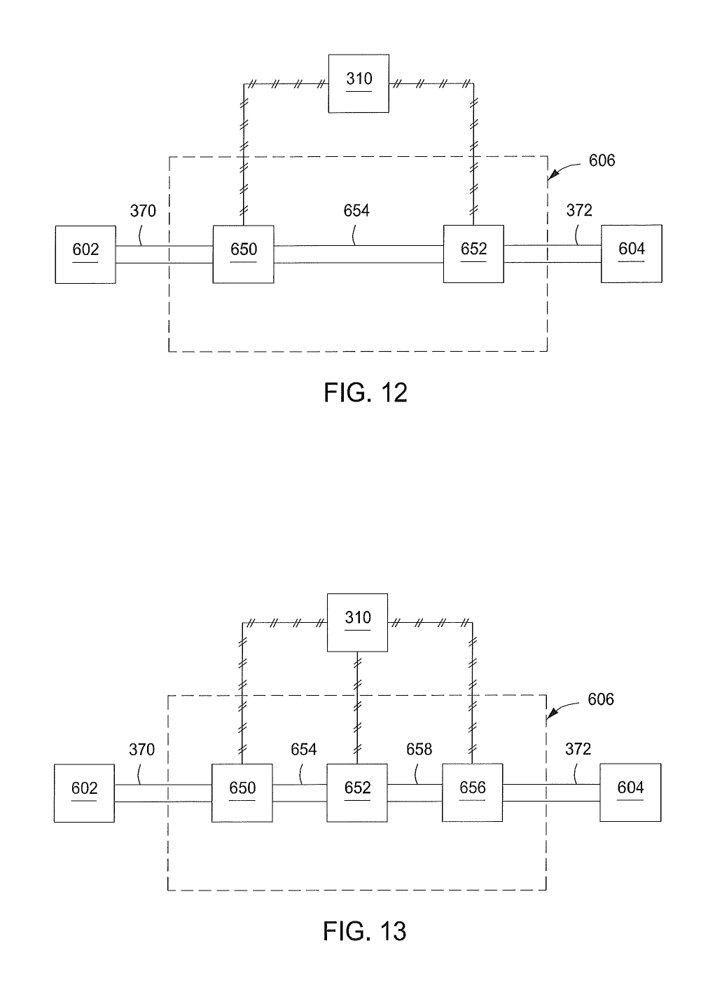

FIG. 12 shows a schematic view of a motor unit 606, according to an aspect of the disclosure. The motor unit 606 illustrated in FIG. 12 includes a first motor 650 and a second motor 652. The first motor is operatively coupled to the recirculation pump unit 602 via the shaft 370, and operatively coupled to the second motor 652 via a shaft 654. The second motor 652 is also operatively coupled to the delivery pump unit 604 via the shaft 372. The first motor 650 and the second motor 652 are each operatively coupled to the module controller 310 for control thereof.

It will be appreciated that the shaft 370, the shaft 654, and the shaft 372 may be integrated into one unitary shaft, or comprise a plurality of shafts fastened together for transmitting torque therebetween. According to an aspect of the disclosure, each of the shaft 370, the shaft 654, and the shaft 372 rotates at the same rotational speed.

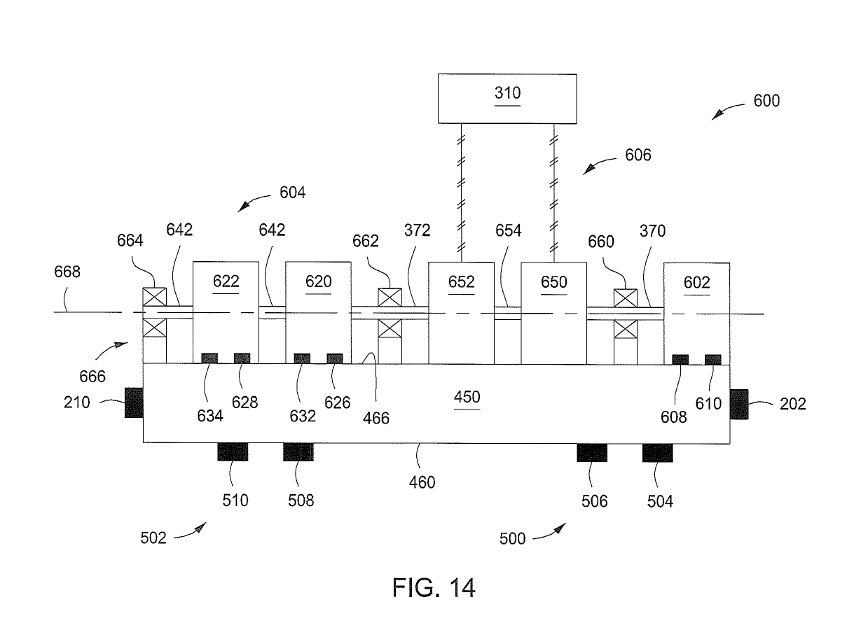

FIG. 13 shows a schematic view of a motor unit 606, according to an aspect of the disclosure. Similar to FIG. 12, the motor unit 606 illustrated in FIG. 13 includes a first motor 650 and a second motor 652, but the motor unit 606 illustrated in FIG. 13 further includes a third motor 656. The third motor 656 is operatively coupled to the second motor 652 via a shaft 658, and operatively coupled to the delivery pump unit 604 via the shaft 372. The third motor 656 is also operatively coupled to the module controller 310 for control thereof.

It will be appreciated that the shaft 370, the shaft 654, the shaft 658, and the shaft 372 may be integrated into one unitary shaft, or comprise a plurality of shafts fastened together for transmitting torque therebetween. According to an aspect of the disclosure, each of the shaft 370, the shaft 654, the shaft 658, and the shaft 372 rotates at the same rotational speed. According to another aspect of the disclosure, the first motor 650, the second motor 652, the third motor 656, or combinations thereof, are brushless DC electric motors.

FIG. 14 shows a schematic side view of a fluid conditioning module 600, according to an aspect of the disclosure. The fluid conditioning module 600 of FIG. 14 includes a recirculation pump unit 602, a motor unit 606, and a delivery pump unit 604, all fastened to a block 450 via threaded fasteners, rivets, welding, brazing, clamps, or any other fastening structures known in the art. Similar to FIGS. 10 and 12, the motor unit 606 includes a first motor 650 and a second motor 652, and the delivery pump unit 604 includes a first delivery pump 620 and a second delivery pump 622. According to an aspect of the disclosure, the recirculation pump unit 602, the motor unit 606, the delivery pump unit 604, or combinations thereof, are fastened to the upper surface 466 of the block 450, opposite the first filter mount 500 and the second filter mount 502 disposed on the lower surface 460 of the block 450.

Similar to FIGS. 6-8, the block 450 in FIG. 14 may define various internal flow passages or flow conduits. For example, the block 450 may define fluid conduits to effect fluid communication between the inlet 610 to the recirculation pump unit 602 and the module inlet port 202, and between the outlet 608 of the recirculation pump unit 602 and the inlet port 504 of the first filter mount 500. The block 450 may further define fluid conduits to effect fluid communication between the outlet port 506 of the first filter mount 500 and the inlet 626 of the first delivery pump 620 and the inlet 628 of the second delivery pump 622, and effect fluid communication between the outlet 632 of the first delivery pump 620 and the outlet 634 of the second delivery pump 622 and the inlet port 508 of the second filter mount 502. The block 450 may further define fluid conduits to effect fluid communication between the outlet port 510 of the second filter mount 502 and the module outlet port 210. Thus, the block 450 may define the inlet manifold 630, the outlet manifold 636, or both, illustrated in FIG. 10. However, it will be appreciated that any of the above-described fluid conduits could be defined, either entirely or in part, by structures such as tubes or pipes distinct from the block 450.

As shown in FIG. 14, the first motor 650 may be operatively coupled to the second motor 652 by the shaft 654, such that the first motor 650 and the second motor 652 are disposed adjacent to one another. Further, the first delivery pump 620 may be operatively coupled to the second delivery pump 622 by the shaft 624, such that the first delivery pump 620 is disposed adjacent to the second delivery pump 622.

A bearing 660 may be fastened to the block 450, and disposed on the shaft 370 between the recirculation pump unit 602 and the first motor 650, for rotational support of the shaft 370. A bearing 662 may be fastened to the block 450, and disposed on the shaft 372 between the second motor 652 and the first delivery pump 620, for rotational support of the shaft 372. A bearing 664 may be fastened to the block 450, and disposed on the shaft 624 on an outboard side 666 of the second delivery pump 622, for rotational support of the shaft 624. Alternatively or additionally, the bearing 660, the bearing 662, the bearing 664, or combinations thereof, may be incorporated into one or more of the recirculation pump unit 602, the motor unit 606, and the delivery pump unit 604.

According to an aspect of the disclosure, longitudinal axes for each of the shaft 370, the shaft 654, the shaft 372, and the shaft 624 are all parallel to one another. According to another aspect of the disclosure, longitudinal axes for each of the shaft 370, the shaft 654, the shaft 372, and the shaft 624 are all coincident with one another along a common shaft longitudinal axis 668. However, it will be appreciated that other arrangements of the shaft longitudinal axes are contemplated to be within the scope of the disclosure.

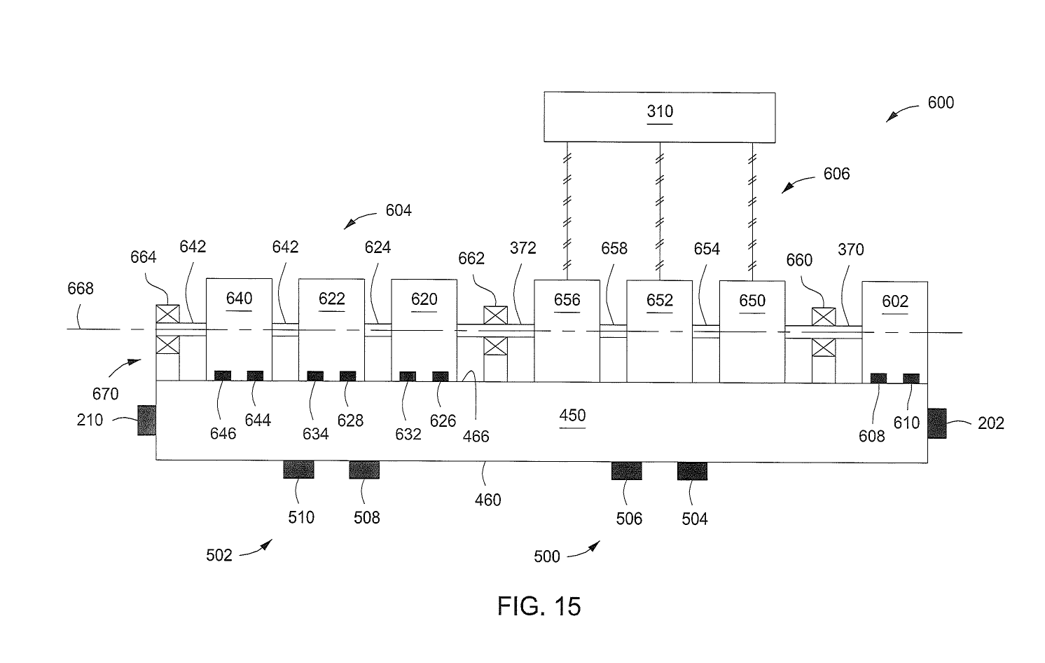

FIG. 15 shows a schematic side view of a fluid conditioning module 600, according to an aspect of the disclosure. The fluid conditioning module 600 of FIG. 15 includes a recirculation pump unit 602, a motor unit 606, and a delivery pump unit 604, all fastened to a block 450 via threaded fasteners, rivets, welding, brazing, clamps, or any other fastening structures known in the art. Similar to FIG. 14, the motor unit 606 includes a first motor 650 and a second motor 652, and the delivery pump unit 604 includes a first delivery pump 620 and a second delivery pump 622; however, the motor unit 606 of FIG. 15 further includes a third motor 656, and the delivery pump unit 604 further includes a third delivery pump 640.

Similar to FIG. 14, the block 450 in FIG. 15 may define various internal flow passages or flow conduits. For example, in addition to the fluid conduits defined by the block 450 in and discussed with respect to FIGS. 6-8 and 14, the block 450 may further define fluid conduits to effect fluid communication between the outlet port 506 of the first filter mount 500 and the inlet 644 to the third delivery pump 640, and between the outlet 646 of the third delivery pump 640 and the inlet port 508 of the second filter mount 502. Thus, the block 450 may define the inlet manifold 630, the outlet manifold 636, or both, illustrated in FIG. 11. However, it will be appreciated that any of the above-described fluid conduits could be defined, either entirely or in part, by structures such as tubes or pipes distinct from the block 450.

As shown in FIG. 15, the third motor 656 may be operatively coupled to the second motor 652 by the shaft 658, such that the third motor 656 and the second motor 652 are disposed adjacent to one another. Further, the third delivery pump 640 may be operatively coupled to the second delivery pump 622 by the shaft 642, such that the third delivery pump 640 is disposed adjacent to the second delivery pump 622.

A bearing 662 may be fastened to the block 450, and disposed on the shaft 372 between the third motor 656 and the first delivery pump 620, for rotational support of the shaft 372. A bearing 664 may be fastened to the block 450, and disposed on the shaft 642 on an outboard side 670 of the third delivery pump 640, for rotational support of the shaft 642. Alternatively or additionally, the bearing 660, the bearing 662, the bearing 664, or combinations thereof, may be incorporated into one or more of the recirculation pump unit 602, the motor unit 606, and the delivery pump unit 604.

According to an aspect of the disclosure, longitudinal axes for each of the shaft 370, the shaft 654, the shaft 658, the shaft 372, the shaft 624, and the shaft 642 are all parallel to one another. According to another aspect of the disclosure, longitudinal axes for each of the shaft 370, the shaft 654, the shaft 658, the shaft 372, the shaft 624, and the shaft 642 are all coincident with one another along a common shaft longitudinal axis 668. However, it will be appreciated that other arrangements of the shaft longitudinal axes are contemplated to be within the scope of the disclosure.

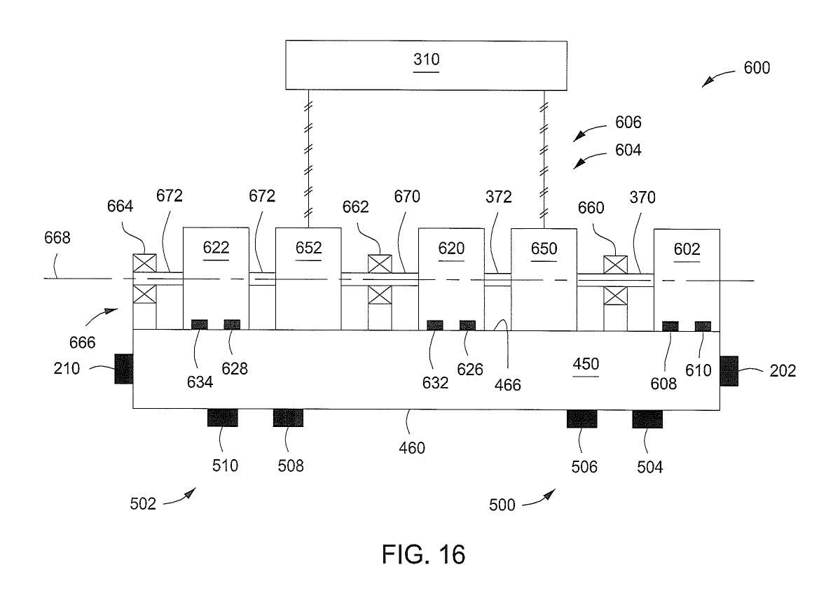

FIG. 16 shows a schematic side view of a fluid conditioning module 600, according to an aspect of the disclosure. The fluid conditioning module 600 of FIG. 16 includes a recirculation pump unit 602, a motor unit 606, and a delivery pump unit 604, all fastened to a block 450 via threaded fasteners, rivets, welding, brazing, clamps, or any other fastening structures known in the art. Similar to FIG. 14, the motor unit 606 includes a first motor 650 and a second motor 652, the delivery pump unit 604 includes a first delivery pump 620 and a second delivery pump 622, and the block 450 in FIG. 16 may define any of the various internal flow passages or flow conduits defined in or discussed with respect to FIGS. 6-8 and 14.

However, in FIG. 16 the elements of the motor unit 606 and the delivery pump unit 604 are interspersed with one another along the block 450. The first delivery pump 620 is operatively coupled to the first motor 650 by the shaft 372, and operatively coupled to the second motor 652 by the shaft 670. Further, the second motor 652 is operatively coupled to the second delivery pump 622 by the shaft 672. Thus, the first motor 650 may be disposed adjacent to the first delivery pump 620, and the second motor 652 may be disposed adjacent to the second delivery pump 622.

A bearing 662 may be fastened to the block 450, and disposed on the shaft 670 between the second motor 652 and the first delivery pump 620, for rotational support of the shaft 670. A bearing 664 may be fastened to the block 450, and disposed on the shaft 672 on an outboard side 666 of the second delivery pump 622, for rotational support of the shaft 672. Alternatively or additionally, the bearing 660, the bearing 662, the bearing 664, or combinations thereof, may be incorporated into one or more of the recirculation pump unit 602, the motor unit 606, and the delivery pump unit 604.

According to an aspect of the disclosure, longitudinal axes for each of the shaft 370, the shaft 372, the shaft 670, and the shaft 672 are all parallel to one another. According to another aspect of the disclosure, longitudinal axes for each of shaft 370, the shaft 372, the shaft 670, and the shaft 672 are all coincident with one another along a common shaft longitudinal axis 668. However, it will be appreciated that other arrangements of the shaft longitudinal axes are contemplated to be within the scope of the disclosure.

### INDUSTRIAL APPLICABILITY

The present disclosure is applicable to fluid conditioning systems and, more particularly, to fuel conditioning modules for combustion engines.

Fuel injection pressures for direct injection compression ignition engines have increased over time at least partly in response to more stringent emissions regulations and incentives to improve fuel economy. And in response to this trend, Applicants have discovered that fuel injection system designs for higher injection pressures may exhibit higher sensitivity to fuel cleanliness, especially with respect to fuel-borne particulates. Further, the increased particulate sensitivity extends not only to the total volume fraction of particulates in the fuel, but also the maximum tolerable particle size. In turn, improved fuel filtration and conditioning systems can improve component service life through mitigation of surface wear and scuffing, heat-induced wear, or combinations thereof.

While conventional methods exist for improving filtration of fuel in a machine 100, Applicants recognized that the conventional methods tend to be bulky and expensive. As a result, Applicants have developed improvements to the conventional filtering methods within current design constraints for product packaging, cost, and maintainability, as described herein.

Referring to FIGS. 3 and 4, aspects of the disclosure provide a fluid conditioning module 200 including a first pump 300 operating in a fluid recirculation loop 328 with a first filter 304, in addition to a second pump 302 for delivering fuel from the fluid recirculation loop 328 to an engine 104 via a second filter 306. Applicants discovered that improved fuel filtering could be achieved within the aforementioned packaging, cost, and maintainability constraints by operating the first pump 300 a flow rate that is at least twice as high as the flow rate through the second pump 302. According to an aspect of the disclosure, the flow rate through the first pump 300 is greater than or equal to five times greater than the flow rate through the second pump 302.

As a result, a parcel of fuel entering the fluid conditioning module 200 from the fuel reservoir 206 will likely flow through the first filter 304 multiple times before advancing to the engine 104 via the second pump 302 and the second filter 306, thereby improving fuel quality with each successive pass through the first filter 304. While some conventional systems may effect so-called “kidney loop” operation with a separate system that recirculates fuel back to a fuel reservoir, Applicants discovered packaging and cost advantages by incorporating the fluid recirculation loop 328 into the fluid conditioning module 200 without recirculation to the fuel reservoir 206. Instead, the second pump 302 takes suction from the fluid node 324, which is in fluid communication with the outlet port 322 of the first filter 304. In turn, Applicants have identified improvements in fuel system component service life, especially for components operating downstream of a high-pressure common rail pump 252 (e.g., high-pressure common rail fuel injectors 254) within established limits for fuel system packaging size and cost.

Accordingly, during operation of the fluid conditioning module, a first flow of fuel enters the inlet 312 of the first pump 300. The first flow of fuel may have originated from the inlet port 202 to the fluid conditioning module 200, the fluid recirculation loop 328, the pressure regulating valve 350, or combinations thereof. The first pump 300 drives the first flow of fuel through the first filter 304 and back to the fluid node 324.

At node 324, the first flow of fuel may be split into a second flow of fuel that proceeds back to the inlet 312 of the first pump 300, and a third flow of fuel that proceeds to the inlet 330 of the second pump 302. According to an aspect of the disclosure, the second flow of fuel constitutes about 50-75% of the first flow of fuel, with the balance proceeding to the inlet 330 of the second pump 302.

Improvements to filtration performance are further realized by pressurization of the fuel entering the first filter 304 by the first pump 300, which enables the use of finer filtration media in the first filter 304, the second filter 306, or both. For example, while some conventional approaches may only accommodate 10 μm filtration media within prescribed design constraints, aspects of the present disclosure enable use of finer 4 μm filtration media within the same design constraints; thereby further improving filtration performance and fuel quality. According to an aspect of the disclosure, the first filter 304 includes a single stage of 4 μm filtration media. According to another aspect of the disclosure, the first filter 304 includes a single stage of 4 μm filtration media, and the second filter 306 includes two stages of 4 μm filtration media arranged in series. According to another aspect of the disclosure, the two stages of 4 μm filtration media in the second filter 306 are arranged coaxially in series with one another. However, persons having skill in the art will appreciate that either the first filter 304 or the second filter 306 may include multiple filter elements in a single filter housing, multiple filter housings, or combinations thereof.

According to an aspect of the disclosure, the module controller 310 is configured to operate the first pump 300 with a discharge pressure at the outlet 316 up to about 18 psi (125 kPa). According to another aspect of the disclosure, the module controller 310 is configured to operate the second pump 302 with a discharge pressure at the outlet 334 of about 87 psi (600 kPa). Thus, it will be appreciated that the fluid conditioning module 200 does not include a high-pressure common rail pump capable of increasing fuel pressure to the final injection pressure. Instead, according to some aspects of the disclosure, the fluid conditioning module 200 performs a low-pressure transfer function to supply high-quality fuel to a high-pressure common rail pump 252.

The module controller 310 is configured to operate the first pump 300 at a flow rate that is higher than a flow rate of the second pump 302, and the module controller 310 may achieve this result in a number of ways depending upon the application.

Referring to FIG. 3, where both the first pump 300 and the second pump 302 are driven by a single motor 308, the first pump 300 may be selected to have a pumping characteristic such that, at the target pressure rise across the first pump, the flow rate through the first pump 300 is greater than the flow rate through the second pump 302, when the second pump 302 is also operated at its target pressure rise and the second pump 302 is operated at the same speed as the first pump 300. Accordingly, for the aforementioned pumping characteristics and same-speed operation of the first pump 300 and the second pump 302, the module controller 310 is configured to operate the first pump 300 at a higher flow rate than that of the second pump 302 by operating both the first pump 300 and the second pump 302 at the same speed.

Alternatively, as discussed above, the motor 308 may include gearing 374, such that the first pump 300 operates at a higher speed than the second pump 302 for any given operating speed of the motor 308. Accordingly, for the configuration where the first pump 300 and the second pump 302 have substantially the same pumping characteristic, operating the first pump 300 at a higher speed than the second pump 302, as a result of the gearing 374, the controller may be configured to operate the first pump 300 at a higher flow rate than that of the second pump 302 by operating the motor 308 at a given speed or range of speeds. Further, it will be appreciated that the gearing 374 may be combined with different pumping characteristics for the first pump 300 and the second pump 302 to achieve the desired relative flow rates between the first pump 300 and the second pump 302.

Referring now to FIG. 4, where the first pump 300 and the second pump 302 are operated independently by separate motors 400 and 402, respectively, it will be appreciated that the module controller 310 may be configured to tailor the flow rate of the first pump 300 relative to the flow rate of the second pump 302 by operating the first motor 400 and the second motor 402 at different speeds. As discussed previously, the first motor 400 and the second motor 402 may be variable speed motors, for example, and the module controller 310 may tailor the speeds of the first motor 400 and the second motor 402 to achieve the desired relative flow rates from the first pump 300 and the second pump 302.

Alternatively, if one of the first motor 400 and the second motor 402 were a variable speed motor and the other were a fixed speed motor, the module controller 310 could tailor the relative flow rates between the first pump 300 and the second pump 302 by varying the speed of the motor having variable speed capability. Further still, if the first motor 400 and the second motor 402 were each fixed speed motors, then the fixed speeds of the two motors could be selected in combination with the pumping characteristics of the first pump 300 and the second pump 302 to effect the desired relative flow rates between the first pump 300 and the second pump 302. Accordingly, the module controller 310 would be configured to operate the first pump 300 at a higher flow rate than the second pump 302 by operating the two fixed-speed motors 400, 402 at different respective fixed speeds.

Similar to operation of the first pump 300 and the second pump 302, the module controller 310 may be configured to operate the recirculation pump unit 602 and the delivery pump unit 604 such that a flow rate through the recirculation pump unit 602 is greater than a flow rate through the delivery pump unit 604. Further, it will be appreciated that any of the aforementioned operating methods or procedures applicable to the first pump 300 and the second pump 302 may be effected for the recirculation pump unit 602 and the delivery pump unit 604, respectively, by action of the module controller 310.

The module controller 310 may be configured to monitor the operating speed of the motor 308, the first motor 400, the second motor 402, or combinations thereof, for purposes of identifying a filter loading level of the first filter 304, the second filter 306, or both. Further, the module controller 310 may be configured to monitor a signal from the pressure sensor 376 and compare the pressure signal to a prescribed threshold value. The signal from the pressure sensor 376 dropping below the prescribed threshold value may be indicative a high loading state of the first filter 304, the second filter 306, or both. In response to identifying a high loading state of filters within the fluid conditioning module 200, the module controller 310 may be configured to transmit a signal to the machine controller 130 or a display in the machine cab 122 informing an operator of the high filter loading condition within the fluid conditioning module 200.

Electrically driven pumps 300, 302 within the fluid conditioning module 200 may advantageously facilitate priming after filter service, as the engine need not be running to drive either the first pump 300, the second pump 302, or both, but instead use electrical energy stored in a battery to operate the fluid conditioning module 200. Similarly, electrically driven pumps 300, 302 may provide advantages with respect to starting the IC engine 104, because the electrically driven pumps 300, 302 do not require shaft power from the engine to pressurize the high-pressure pump system 250 prior to starting the IC engine 104.

It will be appreciated that standardized, modular, and compact nature of the fluid conditioning module 200 facilitates application and installation engineering, particularly in light of only three connections between the machine 100 and the fluid conditioning module 200, namely: the inlet port 202, the outlet port 210, and the power port 214. Further, the compact and modular design of the fluid conditioning module 200 advantageously lends itself for mounting on a fuel tank or the chassis 114 of a machine 100, thereby avoiding the higher vibration environment of the IC engine 104. Applicants have discovered that vibration may diminish filtration performance through disruption of filter cake captured on filter media of the first filter 304 or the second filter 306.

Moreover, referring to FIGS. 9-16, aspects of the disclosure provide a fluid conditioning system having a fluid capacity that is scalable using modular components. For example, the fluid capacity of the delivery pump unit 604 may be tailored to a particular application by choosing an appropriate number of modular delivery pumps greater than or equal to one. For example, FIGS. 10, 14, and 16 illustrate non-limiting configurations for the fluid conditioning module 600 including a first delivery pump 620 and a second delivery pump 622; and FIGS. 11 and 15 illustrate non-limiting configurations for the fluid conditioning module 600 including a first delivery pump 620, a second delivery pump 622, and a third delivery pump 640.

Further, the shaft power capacity of the motor unit 606 may be tailored to a particular application by choosing an appropriate number of modular motors greater than or equal to one. For example, FIGS. 12, 14, and 16 illustrate non-limiting configurations for the fluid conditioning module 600 including a first motor 650 and a second motor 652; and FIGS. 13 and 15 illustrate non-limiting configurations for the fluid conditioning module 600 including a first motor 650, a second motor 652, and a third motor 656.

According to an aspect of the disclosure, each delivery pump of the delivery pump unit 604 has a common operating characteristic, such as a common characteristic relationship between flow rate, pressure rise, and speed, for example. According to another aspect of the disclosure, each motor in the motor unit 606 has a common operating characteristic, such as a common characteristic relationship between shaft torque, shaft speed, electric current, and electric voltage, for example. Therefore, a manufacturer or operator of the fluid conditioning module 600 need only stock a single model of delivery pump, motor, or both, to accommodate an array of fluid capacities for the delivery pump unit 604.

Moreover, when the recirculation pump unit 602 unit includes a centrifugal pump, a common centrifugal pump housing 530 (see FIG. 6) may be used across a range of fluid capacities for the fluid conditioning module 600 by selecting one of a plurality of distinct centrifugal impellers 532 (see FIG. 6) for use in the common centrifugal housing 530. Therefore, a manufacturer or operator of the fluid conditioning module 600 need only stock a single common centrifugal pump housing 530 for the recirculation pump unit 602 to accommodate an array of fluid capacities for the recirculation pump unit 602.

Aspects of the disclosure that use one or more identical electric motors for the motor unit 606 enable reduced cost through simplified design of the module controller 310. Indeed, a common motor controller architecture may be advantageously replicated in the module controller 310 to accommodate any number of modular electric motors in the motor unit 606, compared to manufacturing or purchasing a plurality of different controller architectures.

In addition to economies related to reduced inventory part numbers, modular components having common operating characteristics for the fluid conditioning module 600 may also provide cost savings to manufacturers and operators of the fluid conditioning module 600 by increasing the volumes of modular components manufactured or purchased, instead of purchasing lower quantities across a plurality of components having different operating characteristics. Accordingly, aspects of the disclosure enable reduced manufacturing and operating costs of a family of fluid conditioning modules 600 spanning a wide range of fluid capacities.

Any of the methods or functions described herein may be performed by or controlled by the module controller 310. Further any of the methods or functions described herein may be embodied in a machine-readable non-transitory medium for causing the module controller 310 to perform the methods or functions described herein. Such machine-readable non-transitory media may include magnetic disks, optical discs, solid state disk drives, combinations thereof, or any other machine-readable non-transitory medium known in the art. Moreover, it will be appreciated that the methods and functions described herein may be incorporated into larger control schemes for the engine 104, the machine 100, or combinations thereof, including other methods and functions not described herein. Accordingly, the module controller 310 may be operatively coupled to the machine controller 130 for communication therewith, or at least partly embodied within the machine controller 130.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Unless specified otherwise, use of the word “substantially” herein means “considerable in . . . extent,” or “largely but not necessarily wholly that which is specified.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A fluid conditioning system, comprising:
a first filter mount having a first filter inlet port and a first filter outlet port;
a motor unit;
a recirculation pump unit operatively coupled to the motor unit, an outlet of the recirculation pump unit being fluidly coupled to the first filter inlet port via a first filter inlet conduit, an inlet of the recirculation pump unit being fluidly coupled to the first filter outlet port via a first filter outlet conduit;
a second filter mount having a second filter inlet port; and
a delivery pump unit operatively coupled to the motor unit,
the delivery pump unit including a plurality of delivery pumps, an inlet of each delivery pump of the plurality of delivery pumps being fluidly coupled to an inlet of the delivery pump unit, and an outlet of each delivery pump of the plurality of delivery pumps being fluidly coupled to an outlet of the delivery pump unit,
the inlet of the delivery pump unit being fluidly coupled to the first filter outlet port via the first filter outlet conduit, and
the outlet of the delivery pump unit being fluidly coupled to the second filter inlet port via a second filter inlet conduit.

2. The fluid conditioning system of claim 1, wherein the plurality of delivery pumps consists of a first delivery pump and a second delivery pump.

3. The fluid conditioning system of claim 2, wherein the motor unit includes a first motor operatively coupled to a second motor via a first shaft.

4. The fluid conditioning system of claim 1, wherein the plurality of delivery pumps consists of a first delivery pump, a second delivery pump, and a third delivery pump.

5. The fluid conditioning system of claim 4, wherein the motor unit includes a first motor operatively coupled to a second motor via a first shaft, and a third motor operatively coupled to the first motor and the second motor via a second shaft.

6. The fluid conditioning system of claim 1, wherein the recirculation pump unit consists of a centrifugal pump.

7. The fluid conditioning system of claim 1, wherein each delivery pump in the plurality of delivery pumps is a positive displacement pump.

8. The fluid conditioning system of claim 7, wherein each delivery pump in the plurality of delivery pumps has a common pumping characteristic.

9. The fluid conditioning system of claim 1, wherein the motor unit includes a plurality of electric motors, each electric motor of the plurality of electric motors having a common operating characteristic.

10. The fluid conditioning system of claim 1, further comprising a first filter removably coupled to the first filter mount, and a second filter removably coupled to the second filter mount.

11. The fluid conditioning system of claim 1, further comprising a pressure regulating valve, an outlet port of the second filter mount being fluidly coupled to the first filter inlet conduit via the pressure regulating valve.

12. The fluid conditioning system of claim 1, further comprising a controller operatively coupled to the recirculation pump unit, the controller being configured to operate the recirculation pump unit at a flowrate that is higher than a flowrate of the delivery pump unit.

13. A fluid conditioning module, comprising:
a block defining a first filter inlet port, a first filter outlet port, a second filter inlet port, and a second filter outlet port;
a recirculation pump unit fastened to the block, an outlet of the recirculation pump unit being fluidly coupled to the first filter inlet port via a first filter inlet conduit defined by the block, an inlet of the recirculation pump unit being fluidly coupled to the first filter outlet port via a first filter outlet conduit defined by the block; and
a delivery pump unit fastened to the block,
the delivery pump unit including a plurality of delivery pumps, an inlet of each delivery pump of the plurality of delivery pumps being fluidly coupled to an inlet of the delivery pump unit, and an outlet of each delivery pump of the plurality of delivery pumps being fluidly coupled to an outlet of the delivery pump unit,
the outlet of the delivery pump unit being fluidly coupled to the second filter inlet port via a second filter inlet conduit defined by the block, and
the inlet of the delivery pump unit being fluidly coupled to the first filter outlet port via the first filter outlet conduit.

14. The fluid conditioning module of claim 13, wherein the block further defines a module inlet port, the inlet of the recirculation pump unit being fluidly coupled to the module inlet port via a module inlet conduit defined by the block.

15. The fluid conditioning module of claim 13, further comprising a motor unit operatively coupled to the recirculation pump unit and the delivery pump unit.

16. The fluid conditioning module of claim 15, wherein
the recirculation pump unit is operably coupled to the motor unit via a first shaft,
the delivery pump unit is operably coupled to the motor unit via a second shaft, and
a longitudinal axis of the first shaft is substantially parallel to a longitudinal axis of the second shaft.

17. The fluid conditioning module of claim 16, wherein the plurality of delivery pumps includes a first delivery pump and a second delivery pump,
wherein the motor unit includes a first motor and a second motor,
wherein the first motor is operatively coupled to the second motor via a third shaft, and
wherein the first delivery pump is operatively coupled to the second delivery pump via a fourth shaft.

18. The fluid conditioning module of claim 16, wherein the plurality of delivery pumps includes a first delivery pump and a second delivery pump,
wherein the motor unit includes a first motor and a second motor,
wherein the first delivery pump is operatively coupled to the first motor via the first shaft and operatively coupled to the second motor via a third shaft, and
wherein the second delivery pump is operatively coupled to the second motor via a fourth shaft.

19. The fluid conditioning module of claim 13, wherein the recirculation pump unit and the delivery pump unit are fastened to a first side of the block, and
wherein the first filter inlet port and the second filter inlet port are defined by apertures through a second side of the block, the second side of the block being opposite the first side of the block.

20. The fluid conditioning module of claim 13, further comprising:
a first filter removably coupled to the block by a first filter mount; and
a second filter removably coupled to the block by a second filter mount,
wherein the first filter mount is configured to removably fasten the first filter to the block such that the first filter inlet port of the block is in fluid communication with an inlet of the first filter, and such that the first filter outlet port of the block is in fluid communication with an outlet of the first filter, and
wherein the second filter mount is configured to removably fasten the second filter to the block such that the second filter inlet port of the block is in fluid communication with an inlet of the second filter, and such that the second filter outlet port of the block is in fluid communication with an outlet of the second filter.
